(19) United States
(12) Patent Application Publication
(10) Pub. No.: US 2020/0293884 A1
(43) Pub. Date: Sep. 17, 2020

(54) IMAGE PROCESSING METHOD AND DEVICE AND TERMINAL

(71) Applicant: BEIJING DAJIA INTERNET INFORMATION TECHNOLOGY CO., LTD, Beijing (CN)

(72) Inventors: Zhiwei ZHANG, Beijing (CN); Fan YANG, Beijing (CN)

(21) Appl. No.: 16/767,945

(22) PCT Filed: Nov. 16, 2018
(86) PCT No.: PCT/CN2018/115987

§ 371 Date: May 28, 2020

(30) Foreign Application Priority Data
Nov. 28, 2017 (CN) 201711219332.9

(51) Int. Cl. G06N 3/08; G06K 9/62

(52) U.S. Cl. CPC G06N 3/08; G06K 9/6227

(57) ABSTRACT

Provided in the embodiments of the present application are an image processing method and device and a terminal. The method includes: determining whether a currently pre-called first convolutional layer is equipped with a first selection module during a process of carrying out convolutional processing on an image by means of a convolutional neural network; if the first convolutional layer is equipped with the first selection module, inputting output data of the previous convolutional layer into the first selection module and the first convolutional layer respectively; calling the first selection module, and using the first selection module to determine a target feature graph from feature graphs contained in the first convolutional layer according to the output data of the previous convolutional layer; and calling the first convolutional layer, and using the first convolutional layer to carry out convolutional processing on the output data of the previous convolutional layer according to the target feature graph, thereby obtaining output data. With the image processing method provided by the embodiments of the present application, the amount of calculation may be reduced, thereby improving the task processing efficiency.

### CROSS REFERENCE TO RELATED APPLICATIONS

The present application is a National Stage of International Application No PCT/CN2018/115987, filed on Nov. 16, 2018, which claims priority to Chinese Patent Application No. 201711219332.9, entitled ‘Image Processing Method and Device and Terminal’, filed in the Chinese Patent Office on Nov. 28, 2017, and granted by the Chinese Patent Office on Nov. 16, 2018, the entire contents of which are incorporated herein by reference.

### FIELD

The present application relates to the technical field of image processing, in particular to an image processing method and device and a terminal.

### BACKGROUND

Depth learning has been widely used in related fields such as video images, speech recognition and natural language processing. A convolutional neural network is an important branch of the depth learning, and because of its strong fitting ability and end-to-end global optimization ability, the accuracy of prediction results of the convolutional neural network in computer vision tasks including target detection, classification and the like is greatly improved.

### SUMMARY

According to one aspect of the present application, a method for processing image is provided, which includes the following steps: determining whether a first convolutional layer pre-called currently includes a first slice selection module during a process of carrying out convolutional processing on an image by means of a convolutional neural network, wherein the convolutional neural network includes a plurality of convolutional layers, and each of the convolutional layer includes a plurality of feature maps; inputting output data of the previous convolutional layer into the first slice selection module and the first convolutional layer respectively, in response to that the first convolutional layer includes the first slice selection module; calling the first slice selection module, and determining a target feature map by the first slice selection module based on the feature maps of the first convolutional layer and the output data of the previous convolutional layer; and calling the first convolutional layer, and carrying out by the first convolutional layer, convolutional processing on the output data of the previous convolutional layer based on the target feature map, thereby obtaining output data.

In some embodiments, the calling the first slice selection module, and determining the target feature map by the first slice selection module based on the feature maps of the first convolutional layer and the output data of the previous convolutional layer includes: calling the first slice selection module, and generating a feature map weight vector by the first slice selection module based on the output data of the previous convolutional layer, wherein each point in the feature map weight vector corresponds to one of the feature maps in the first convolutional layer and a weight value; determining a number N of target features based on a preset acceleration ratio; and adjusting the weight values of other points except the first N points in the feature map weight vector to 0, and inputting the adjusted feature map weight vector into the first convolutional layer, wherein a feature map corresponding to the first N points are is the target feature map.

In some embodiments, the calling the first convolutional layer, and carrying out by the first convolutional layer, convolutional processing on the output data of the previous convolutional layer based on the target feature map, thereby obtaining the output data includes: calling the first convolutional layer, and using the first convolutional layer to determine the target feature map based on the adjusted feature map weight vector; and carrying out convolutional processing on the output data of the previous convolutional layer based on the target feature map to obtain the output data.

In some embodiments, the method further includes: inputting the output data of the previous convolutional layer into the first convolutional layer respectively in response to that the first convolutional layer does not include the first slice selection module; and calling the first convolutional layer, and carrying out convolutional processing on the output data of the previous convolutional layer by the first convolutional layer based on all the contained feature maps to obtain the output data.

According to another aspect of the present application, provided is a device for processing image, the device includes a determining module configured to determine whether a first convolutional layer pre-called currently includes a first slice selection module during a process of carrying out convolutional processing on an image by means of a convolutional neural network, wherein the convolutional neural network includes a plurality of convolutional layers, and each of the convolutional layers includes a plurality of feature maps; a first inputting module configured to input the output data of the previous convolutional layer into the first slice selection module and the first convolutional layer respectively in response to that the first convolutional layer includes the first slice selection module; a first calling module configured to call the first slice selection module, and use the first slice selection module to determine a target feature map based on the feature maps of the first convolutional layer and the output data of the previous convolutional layer; and a second calling module configured to call the first convolutional layer, and use the first convolutional layer to carry out convolutional processing on the output data of the previous convolutional layer based on the target feature map, thereby obtaining output data.

In some embodiments, the first slice selection module is configured to: generate a feature map weight vector based on the output data of the previous convolutional layer, wherein each point in the feature map weight vector corresponds to one of the feature maps in the first convolutional layer and a weight value; determine a number N of target features based on a preset acceleration ratio; and adjust the weight values of other points except the first N points in the feature map weight vector to 0, and input the adjusted feature map weight vector into the first convolutional layer, wherein a feature map corresponding to the first N points is a target feature map.

In some embodiments, the first convolutional layer is configured to: determine the target feature map based on the adjusted feature map weight vector; and carry out convolutional processing on the output data of the previous convolutional layer based on the target feature map to obtain the output data.

In some embodiments, the device further includes a second inputting module and a third calling module, wherein the second inputting module is configured to respectively input the output data of the previous convolutional layer into the first convolutional layer in response to that the first convolutional layer does not include the first slice selection module; and the third calling module is configured to call the first convolutional layer, and use the first convolutional layer to carry out convolutional processing on the output data of the previous convolutional layer based on all contained feature maps to obtain the output data.

According to another aspect of the present application, provided is another method for processing image, and the method includes:

inputting an image into a convolutional neural network and carrying out a convolutional processing on the image, wherein the convolutional neural network includes a plurality of convolutional layers, and at least one convolutional layer is provided with a slice selection module;

the carrying out convolutional processing on the image by the convolutional neural network includes:

carrying out convolutional processing on output data of the previous convolutional layer by a first convolutional layer including a first slice selection module to obtain alternative feature maps; and

determining a target feature map by the first slice selection module based on the alternative feature maps and the output data of the previous convolutional layer as output data of the first convolutional layer.

In some embodiments, the determining the target feature map by the first slice selection module based on the alternative feature maps by the first slice selection module and the output data of the previous convolutional layer includes:

generating a feature map weight vector by the first slice selection module based on the output data of the previous convolutional layer, wherein weight values in the feature map weight vector are in one-by-one correspondence to the alternative feature maps;

determining a number N of target features based on a preset acceleration ratio;

adjusting other weight values except the first largest N weight values in the feature map weight vector to 0; and

determining the target feature map based on the alternative feature maps and the adjusted feature map weight vector.

In some embodiments, the first slice selection module includes a fully connected layer;

the generating the feature map weight vector by the first slice selection module based on the output data of the previous convolutional layer includes:

processing the output data of the previous convolutional layer by adopting a global-average-pooling algorithm; and

inputting a processing result into the fully connected layer to obtain the feature map weight vector.

According to yet another aspect of the present application, provided is a terminal which includes a memory, a processor and an image processing program which is stored on the memory and may run on the processor, and when the image processing program is executed by the processor, any of the image processing methods in the present application are implemented.

According to yet another aspect of the present application, provided is a computer readable storage medium, an image processing program is stored on the computer readable storage medium, and when the image processing program is executed by the processor, any of the image processing methods in the present application are implemented.

According to yet another aspect of the present application, provided is an application program product, and the application program product is used for executing any of the image processing methods in the present application during running.

### BRIEF DESCRIPTION OF THE DRAWINGS

Various advantages and benefits will become apparent to those of ordinary skill in the art upon reading the following detailed description of the preferred embodiments. The drawings are only for purposes of illustrating the preferred embodiments and are not to be construed as limiting the present application. Moreover, throughout the drawings, like reference numerals designate like parts.

FIG. 1 is a flowchart of steps of an image processing method according to Embodiment 1 of the present application;

FIG. 2 is a flowchart of steps of an image processing method according to Embodiment 2 of the present application;

FIG. 3 is a structure block diagram of an image processing device according to Embodiment 3 of the present application; and

FIG. 4 is a structure block diagram of a terminal according to Embodiment 4 of the present application.

### DETAILED DESCRIPTION OF THE EMBODIMENTS

Exemplary embodiments of the present application will be described in more detail below with reference to the accompanying drawings. Although exemplary embodiments of the present application are shown in the drawings, it is to be understood that the present application may be embodied in various forms and should not be limited to the embodiments set forth herein. Rather, these embodiments are provided so that the present application will be thorough and complete, and will fully convey the scope of the present application to those skilled in the art.

### Embodiment 1

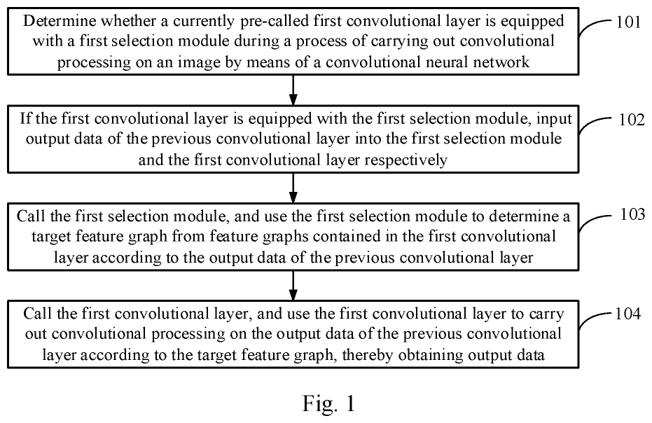

Referring to FIG. 1, a flowchart of steps of an image processing method according to Embodiment 1 of the present application is shown.

In some embodiments, the image processing method may include the following steps:

Step 101: determining whether a first convolutional layer pre-called currently includes a first slice selection module during a process of carrying out convolutional processing on an image through a convolutional neural network.

The convolutional neural network includes a plurality of convolutional layers, and each convolutional layer includes a plurality of feature maps. A slice selection module can be arranged for one convolutional layer based on practical requirements, and slice selection modules can be arranged for multiple convolutional layers respectively.

The image in the embodiment of the present application can be a single frame image in a video or only one multimedia image. An image is input into the convolutional neural network, and feature maps are obtained after processing by various convolutional layers. In the convolutional neural network, output data of the previous convolutional layer are used as input data of the next convolutional layer, and a final result is obtained after layer-by-layer convolutional processing.

Step 102: if the first convolutional layer includes the first slice selection module, inputting the output data of the previous convolutional layer into the first slice selection module and the first convolutional layer respectively.

The output data of the convolutional layer is a corresponding feature map of an image to be processed in the convolutional layer. The image to be processed is the image input to the convolutional neural network for convolutional processing.

Step 103: calling the first slice selection module to, and using the first slice selection module to determine a target feature map from feature maps contained in the first convolutional layer based on output data of the previous convolutional layer.

The output data of the previous convolutional layer are a plurality of feature maps, and the first slice selection module establishes association processing between each feature map and the corresponding feature map contained in the first convolutional layer to determine a preset number of target feature maps which have a high matching degree with the output data.

Step 104: calling the first convolutional layer to and using the first convolutional layer to carry out convolutional processing on the output data of the previous convolutional layer by the first convolutional layer based on the target feature map to obtain output data.

As another implementation mode, when a convolutional neural network carries out convolutional processing on an image, for a first convolutional layer provided with a first slice selection module, output data of the previous convolutional layer are respectively input into the first slice selection module and the first convolutional layer, and the first convolutional layer can carry out convolutional processing on the output data of the previous convolutional layer so as to obtain alternative feature maps. The first slice selection module may determine a target feature map from the alternative feature maps based on the output data of the previous convolutional layer, and the determined target feature map is taken as output data of the first convolutional layer.

For a second convolutional layer which does not include a slice selection module, the second convolutional layer can carry out convolutional processing on the output data of the previous layer to obtain a plurality of feature maps, and the feature maps are output data of the second convolutional layer.

A specific manner in which the convolutional layers carry out convolutional processing on the input data based on the feature maps can be seen with reference to an existing related technology and will not be described in detail in the embodiment of the present application.

After the first convolutional layer and the first slice selection module process the output data of the previous convolutional layer, the data are output to the next convolutional layer; the next convolutional layer executes processes in the steps 101 to 104 to obtain output data, the output data are input to the next convolutional layer, and when each convolutional layer processes the output data of the previous convolutional layer, the steps 101 to 104 are executed until each convolutional layer in the convolutional neural network is executed completely, and the feature map corresponding to the image is predicted.

Based on the image processing method provided by the embodiment of the present application, the slice selection module is arranged for one or more convolutional layers in the convolutional neural network in advance, in a process of predicting the image by the convolutional neural network, the feature maps in the convolutional layers are screened through the slice selection module, convolutional output is calculated by selecting part of the feature maps from the feature maps contained in the convolutional layers as the target feature maps, and compared with an existing image processing method in which the feature maps in the convolutional layers are not screened, and the various feature maps contained in the convolutional layers are taken as target feature maps to calculate convolutional output, the image processing method provided by the embodiment of the present application has the characteristic that the amount of calculation can be reduced, and thus, the task processing efficiency is improved.

### Embodiment 2

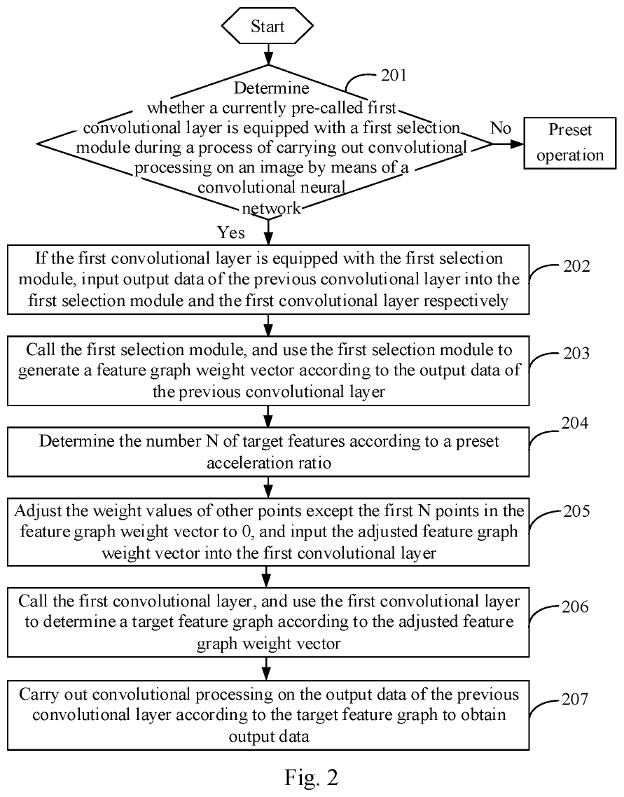

Referring to FIG. 2, a flowchart of steps of an image processing method of Embodiment 2 of the present application is shown.

The image processing method in the embodiment of the present application may specifically include the following steps.

Step 201: in a process of carrying out convolutional processing on an image through a convolutional neural network, determining whether a first convolutional layer pre-called currently includes a first slice selection module or not; if so, step 202 is executed; and if not, preset operation is executed.

The convolutional neural network includes a plurality of convolutional layers, and each convolutional layer includes a plurality of feature maps. A slice selection module can be selectively provided to one or more convolutional layers based on practical requirements. The training mode of a convolutional neural network including a slice selection module is the same as that of a convolutional neural network not including the slice selection module, and therefore, training of the convolutional neural network in the embodiment of the present application refers to the related art, and it is not specifically limited in the embodiment of the present application.

An image is input into the convolutional neural network, and is processed by the various convolutional layers to obtain a feature map. In the convolutional neural network, output data of the previous convolutional layer are used as input data of the next convolutional layer, and a final result is obtained after layer-by-layer convolutional processing. Processing flows of the different convolutional layers to the input data are the same, and the processing flow of a single convolutional layer is illustrated as an example in the embodiment of the present application.

The preset operation may be set to input the output data of the previous convolutional layer into the first convolutional layer when the first convolutional layer does not include the first slice selection module; and the first convolutional layer is called, and the first convolutional layer is used for carrying out convolutional processing on the output data of the previous convolutional layer based on all contained feature maps to obtain output data.

For example, the first convolutional layer contains 100 feature maps, when the output data of the previous convolutional layer are subjected to convolutional processing through the first convolutional layer, the input data input to the first convolutional layer are subjected to convolutional processing based on the 100 feature maps, and a feature map matched with the input data in the convolutional layer is determined as the output data which are input to the next convolutional layer.

Step 202: if the first convolutional layer includes the first slice selection module, inputting the output data of the previous convolutional layer into the first slice selection module and the first convolutional layer respectively.

The output data of the previous convolutional layer are a plurality of feature maps.

Step 203: calling the first slice selection module is called, and using the first slice selection module to generate a feature map weight vector based on the output data of the previous convolutional layer.

Each point in the feature map weight vector corresponds to one of the feature maps in the first convolutional layer and a weight value. The feature map weight vector may be denoted by a.

As another implementation mode, weight values in feature map weight vectors are in one-to-one correspondence to alternative feature maps output by a first convolutional layer.

Step 204: determining the number N of target features based on a preset acceleration ratio.

The preset acceleration ratio may be denoted by along with increasing of the preset acceleration ratio, the number N of the target features is continuously reduced, and along with reduction of the preset acceleration ratio, the number N of the target features is continuously increased. The preset acceleration ratio indicates the degree of improvement of the processing efficiency of the convolutional neural network, along with increasing of the preset acceleration ratio, it shows that the degree of required improvement of the processing efficiency of the convolutional neural network is higher, the number N of the target features is smaller, and therefore, the number of the feature maps needing to be processed in the next convolutional layer is smaller.

In contrast, along with reduction of the preset acceleration ratio, it shows that the degree of required improvement of the processing efficiency of the convolutional neural network is lower, the number N of the target features is larger, therefore, the number of the feature maps needing to be processed in the next convolutional layer is smaller than the number of feature maps needing to be processed in the related art, and the processing efficiency of the convolutional neural network may also be improved.

In some embodiments, a specific numerical value of the acceleration ratio can be set based on practical requirements, and it is not specifically limited in the embodiment of the present application.

Step 205: adjusting the weight values of other points except the first N points in the feature map weight vector to 0, and inputting the adjusted feature map weight vector into the first convolutional layer.

A feature map corresponding to the first N points in the feature map weight vector is a target feature map, the weight value of a certain point in the feature weight vector is adjusted to 0, and it shows that the feature map corresponding to the point does not participate in convolutional processing of input data in the first convolutional layer.

For example, the first convolutional layer contains 100 feature maps, N is 50, and the first 50 feature maps with a high matching degree with the input data are selected from the 100 feature maps to participate in convolutional processing.

Step 206: calling the first convolutional layer and using the first convolutional layer to determine the target feature map based on the adjusted feature map weight vector.

In the adjusted feature weight vector, a feature map corresponding to the point with the weight value being a non-zero value is the target feature map.

Step 207: performing the convolutional processing on the output data of the previous convolutional layer based on the target feature map to obtain output data.

When the output data, namely feature map output, of the first convolutional layer are calculated, Y′=Yσ, wherein Y′ is the output data of the first convolutional layer. Because the feature map with the weight value of 0 in the first convolutional layer is not calculated any more when the output data of the first convolutional layer are calculated, the prediction efficiency of the first convolutional layer is accelerated.

As another implementation mode, after a first slice selection module determines the number N of target features based on a preset acceleration ratio, other weight values except the first largest N weight values in a feature map weight vector can be adjusted to 0, and then a target feature map is determined from alternative feature maps based on the adjusted feature map weight vector.

After the first slice selection module determines the number N of the target features based on the preset acceleration ratio, the weight values in the feature map weight vector can be sorted based on the sequence from large to small, then the first N weight values are reserved, and other weight values except the first N weight values are adjusted to 0.

Furthermore, the first slice selection module may determine the target feature map from the alternative feature maps based on the one-to-one correspondence between the weight values in the feature map weight vector and the alternative feature maps.

For example, the first convolutional layer outputs 10 alternative feature maps which are alternative feature map A to alternative feature map J successively, assuming that the adjusted feature map weight vector is [0,0,a,b,0,c,d,e,0,f], wherein a to f represent weight values which are not zero. Then, based on the one-to-one correspondence between the weight values in the feature map weight vector and the alternative feature maps, the first slice selection module may determine that the alternative feature map C, the alternative feature map D, the alternative feature map F, the alternative feature map G, the alternative feature map H and the alternative feature map J corresponding to the weight values a-f are target feature maps. The target feature maps are the output data of the first convolutional layer.

In one implementation mode, the first slice selection module may include a fully connected layer, and the step of generating by the first slice selection module, the feature map weight vector based on the output data of the previous convolutional layer may include:

processing the output data of the previous convolutional layer by using a global-average-pooling algorithm; and inputting a processing result obtained by processing into the fully connected layer to obtain the feature map weight vector.

After the first slice selection module acquires the output data of the previous convolutional layer, the output data of the previous convolutional layer may be processed by adopting the global-average-pooling algorithm, and then the processing result is obtained. That is, the first slice selection module may carry out global average processing on the feature maps output from the previous convolutional layer, and average values corresponding to the different feature maps are output. Then, the average values can be input into the fully connected layer, the average values are further processed by the fully connected layer to obtain a weight vector corresponding to the average values, and the weight vector output by the fully connected layer may be taken as the feature map weight vector.

Along with increasing of the weight value in the feature map weight vector, it indicates that the image feature included in the corresponding alternative feature map is more important, along with reduction of the weight value, it indicates that the image feature included in the corresponding alternative feature map is less important, therefore, when the weight value in the feature map weight vector is adjusted, the weight value with the smaller value may be adjusted to 0, and the corresponding alternative feature map is discarded, and is no longer input to the next convolutional layer. Therefore, while the accuracy of an image prediction result can be ensured as far as possible, the processing efficiency of the convolutional neural network can be improved as far as possible.

After the first convolutional layer carries out convolutional processing on the output data of the previous convolutional layer, data are output to the next convolutional layer; and the next convolutional layer executes processes from the step 201 to the step 207 to obtain the output data, the output data are input to the next convolutional layer until all the convolutional layers in the convolutional neural network carry out convolutional processing, and then the feature map corresponding to the image is obtained by prediction.

Based on the image processing method provided by the embodiment of the present application, the slice selection module is arranged for one or more convolutional layers in the convolutional neural network in advance, in a process of predicting the image through the convolutional neural network, the feature maps in the convolutional layers are screened through the slice selection module, convolutional output is calculated by selecting part of the feature maps from the feature maps contained in the convolutional layers as target feature maps, compared with an existing image processing method in which the feature maps in the convolutional layers are not screened, and the various feature maps contained in the convolutional layers are taken as target feature maps to calculate the convolutional output, the image processing method provided by the embodiment of the present application has the characteristic that the amount of calculation may be reduced, and thus, the task processing efficiency is improved.

### Embodiment 3

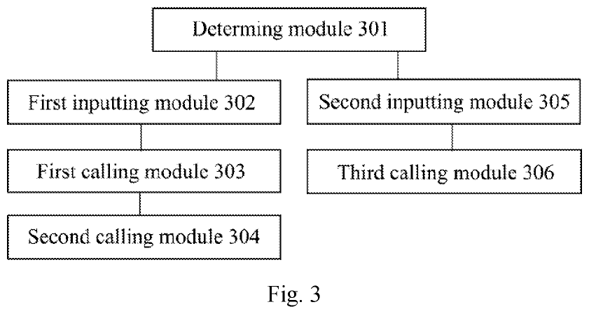

Referring to FIG. 3, a structure block diagram of an image processing device of Embodiment 3 of the present application is shown.

The image processing device of the embodiment of the present application may include a determining module 301 configured to determine whether a first convolutional layer pre-called currently includes a first slice selection module or not in a process of carrying out convolutional processing on an image through a convolutional neural network, wherein the convolutional neural network includes a plurality of convolutional layers, and each convolutional layer includes a plurality of feature maps; a first inputting module 302 configured to respectively input the output data of the previous convolutional layer to the first slice selection module and the first convolutional layer when the first convolutional layer includes the first slice selection module; a first calling module 303 configured to call the first slice selection module, and use the first slice selection module to determine a target feature map from the feature maps contained in the first convolutional layer based on the output data of the previous convolutional layer, and a second calling module 304 configured to call the first convolutional layer, and use the first convolutional layer to carry out convolutional processing on the output data of the previous convolutional layer based on the target feature map to obtain output data.

In some embodiments, the first slice selection module is configured to: generate a feature map weight vector based on the output data of the previous convolutional layer, wherein each point in the feature map weight vector corresponds to one of the feature map in the first convolutional layer and a weight value; determine the number N of target features based on a preset acceleration ratio; and adjust the weight values of other points except the first N points in the feature map weight vector to 0, and input the adjusted feature map weight vector into the first convolutional layer, wherein a feature map corresponding to the first N points is the target feature map.

In some embodiments, the first convolutional layer is configured to: determine the target feature map based on the adjusted feature map weight vector; and carry out convolutional processing on the output data of the previous convolutional layer based on the target feature map to obtain the output data.

In some embodiments, the device further includes a second inputting module 305 configured to respectively input the output data of the previous convolutional layer into the first convolutional layer when the first convolutional layer does not include the first slice selection module, and a third calling module 306 configured to call the first convolutional layer, and use the first convolutional layer to carry out convolutional processing on the output data of the previous convolutional layer based on all the contained feature maps to obtain the output data.

The image processing device of the embodiment of the present application is configured to implement the corresponding image processing methods in Embodiment 1 and Embodiment 2, and has beneficial effects corresponding to the embodiments of the methods, and it will not be described in detail herein.

### Embodiment 4

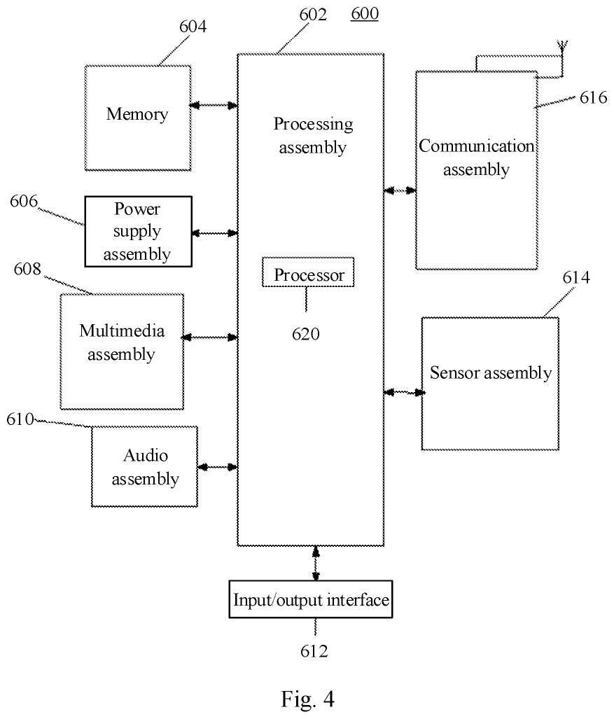

Referring to FIG. 4, a structure block diagram of a terminal for image processing based on Embodiment 4 of the present application is shown.

The terminal of the embodiment of the present application may include a memory, a processor and an image processing program stored on the memory and operable on the processor, and when the image processing program is executed by the processor, the steps of any of the image processing methods in the present application are implemented.

FIG. 4 is a block diagram of an image processing terminal 600 based on an exemplary embodiment. For example, the terminal 600 may be a mobile phone, a computer, a digital broadcast terminal, message receiving and transmitting equipment, a game console, a tablet device, medical equipment, fitness equipment, personal digital assistant and the like.

Referring to FIG. 4, the terminal 600 may include one or more of the following assemblies: a processing assembly 602, a memory 604, a power supply assembly 606, a multimedia assembly 608, an audio assembly 610, an input/output (I/O) interface 612, a sensor assembly 614 and a communication assembly 616.

The processing assembly 602 generally controls overall operation of the device 600, such as operations associated with display, telephone calls, data communications, camera operations and recording operations. The processing assembly 602 may include one or more processors 620 to execute instructions to complete all or part of the steps of the above methods. In addition, the processing assembly 602 may include one or more modules to facilitate interaction between the processing assembly 602 and other assemblies. For example, the processing assembly 602 may include a multimedia module to facilitate interaction between the multimedia assembly 608 and the processing assembly 602.

The memory 604 is configured to store various types of data to support operation at the terminal 600. Examples of the data include instructions for any application programs or method operated on the terminal 600, contact data, phonebook data, messages, pictures, videos and the like. The memory 604 may be implemented by any type of volatile or nonvolatile memory equipment or combination thereof, such as a static random access memory (SRAM), an electrically erasable programmable read only memory (EEPROM), an erasable programmable read only memory (EPROM), a programmable read only memory (PROM), a read only memory (ROM), a magnetic memory, a flash memory and a magnetic or optical disk.

The power supply assembly 606 provides power to the various assemblies of the terminal 600. The power supply assembly 606 may include a power supply management system, one or more power supplies, and other assemblies associated with generating, managing, and distributing power to the terminal 600.

The multimedia assembly 608 includes a screen which provides an output interface between the terminal 600 and a user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, sliding, and gestures on the touch panel. The touch sensor may not only sense boundaries of a touch or sliding action, but also detect a duration and a pressure associated with a touch or sliding operation. In some embodiments, the multimedia assembly 608 includes a front camera and/or a rear camera. When the terminal 600 is in an operation mode, such as a photographing mode or a video mode, the front camera and/or the rear camera may receive external multimedia data. Each of the front camera and the rear camera may be a fixed optical lens system or have focal length and optical zoom capabilities.

The audio assembly 610 is configured to output and/or input audio signals. For example, the audio assembly 610 includes a microphone (MIC) configured to receive external audio signals when the terminal 600 is in an operational mode, such as a call mode, a record mode, and a voice recognition mode. The received audio signals may be further stored in the memory 604 or transmitted via a communication assembly 616. In some embodiments, the audio assembly 610 also includes a loudspeaker for outputting the audio signals.

An I/O interface 612 provides an interface between the processing assembly 602 and a peripheral interface module, and the above peripheral interface module may be keyboards, click wheels, buttons and the like. The buttons may include, but are not limited to, a home button, a volume button, a start button and a lock button.

The sensor assembly 614 includes one or more sensors for providing status assessments of various aspects of the terminal 600. For example, the sensor assembly 614 may detect an on/off state of the terminal 600 and relative positioning of the assemblies, for example, the assemblies are a sensor and a keypad of the terminal 600, the sensor assembly 614 may also detect a change in the position of the terminal 600 or one assemble of the terminal 600, the presence or absence of contact between the user and the terminal 600, the orientation or acceleration/deceleration of the device 600, and a change in a temperature of the terminal 600. The sensor assembly 614 may include a proximity sensor configured to detect the presence of a nearby object in the absence of any physical contact. The sensor assembly 614 may also include a light sensor, such as a CMOS or CCD image sensor, for use in imaging applications. In some embodiments, the sensor assembly 614 may also include an acceleration sensor, a gyro sensor, a magnetic sensor, a pressure sensor or a temperature sensor.

The communication assembly 616 is configured to facilitate wired or wireless communication between the terminal 600 and other equipment. The terminal 600 may access a wireless network based on a communication standard, such as WiFi, 2G, or 3G, or a combination thereof. In one exemplary embodiment, the communication assembly 616 receives broadcast signals or broadcast-related information from an external broadcast management system via a broadcast channel. In one exemplary embodiment, the communication assembly 616 also includes a near field communication (NFC) module to facilitate short-range communication. For example, the NFC module may be implemented based on a radio frequency identification (RFID) technology, an infrared data association (IrDA) technology, an ultra wide band (UWB) technology, a Bluetooth (BT) technology and other technologies.

In some embodiments, the terminal 600 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, or other electronic components for performing the image processing method, and the image processing method includes:

determining whether a first convolutional layer pre-called currently includes a first slice selection module during a process of carrying out convolutional processing on an image by means of a convolutional neural network, wherein the convolutional neural network includes a plurality of convolutional layers, and each convolutional layer includes a plurality of feature maps; if the first convolutional layer includes the first slice selection module, inputting output data of the previous convolutional layer into the first slice selection module and the first convolutional layer respectively; calling the first slice selection module and using the first slice selection module to determine a target feature map from feature maps contained in the first convolutional layer based on the output data of the previous convolutional layer; and calling the first convolutional layer and using the first convolutional layer to carry out convolutional processing on the output data of the previous convolutional layer based on the target feature map, thereby obtaining output data.

In some embodiments, the step of calling the first slice selection module, and using the first slice selection module to determine the target feature map from the feature maps contained in the first convolutional layer based on the output data of the previous convolutional layer includes: calling the first slice selection module, and using the first slice selection module to generate a feature map weight vector based on the output data of the previous convolutional layer, wherein each point in the feature map weight vector corresponds to one of the feature map in the first convolutional layer and a weight value; the number N of target features is determined based on a preset acceleration ratio; and adjusting the weight values of other points except the first N points in the feature map weight vector to 0, and inputting the adjusted feature map weight vector into the first convolutional layer, wherein a feature map corresponding to the first N points is the target feature map.

In some embodiments, the step of calling the first convolutional layer, and carrying out convolutional processing on the output data of the previous convolutional layer by the first convolutional layer based on the target feature map to obtain the output data includes: calling the first convolutional layer, and determining by the first convolutional layer, the target feature map based on the adjusted feature map weight vector; and performing a convolutional processing to the output data of the previous convolutional layer based on the target feature map to obtain the output data.

In some embodiments, the method further includes: inputting the output data of the previous convolutional layer respectively into the first convolutional layer when the first convolutional layer does not include the first slice selection module; and calling the first convolutional layer, and carrying out by the first convolutional layer, a convolutional processing on the output data of the previous convolutional layer based on all the contained feature maps to obtain the output data.

In some embodiments, provided is a non-temporary computer readable storage medium including instructions, such as a memory 604 including instructions executable by a processor 620 of the terminal 600 to complete the above image processing method. For example, the non-temporary computer readable storage medium may be a ROM, a random access memory (RAM), a CD-ROM, a magnetic tape, a floppy disk, an optical data storage device, and the like. When the instructions in the storage medium are executed by the processor of the terminal, the terminal can execute steps of any of the image processing methods in the present application.

According to the terminal provided by the embodiment of the present application, the slice selection module is arranged for one or more convolutional layers in the convolutional neural network in advance, in a process of predicting the image by the convolutional neural network, the feature maps in the convolutional layer are screened through the slice selection module, convolutional output is calculated by selecting part of feature maps from the plurality of feature maps contained in the convolutional layers as target feature maps, compared with an existing image processing method in which the feature maps in the convolutional layers are not screened, and the various feature maps contained in the convolutional layers are taken as target feature maps to calculate convolutional output, the image processing method has the characteristic that the amount of calculation may be reduced, and thus, the task processing efficiency is improved.

Some embodiments of the present application further provide an application program product for carrying out the steps of any of the image processing methods in the present application during running.

For the embodiments of the device, the terminal, the computer readable storage medium and the application program product, which are substantially similar to the embodiments of the method, the description is relatively simple and may be seen in part of the description of the embodiments of the method at related positions.

The image processing schemes provided herein are not in inherent correlation with any particular computers, virtual systems or other equipment. Various general-purpose systems may also be used with the teachings herein. The required structure for constructing the system of the scheme of the present application will be apparent from the description above. In addition, the present application is not directed to any particular programming language. It is to be understood that the contents of the present application described herein may be implemented by using a variety of programming languages, and that the foregoing description of specific languages is intended to disclose the preferred embodiments of the present application.

In the specification provided herein, numerous specific details are set forth. It will be understood, however, that embodiments of the present application may be practiced without these specific details. In some instances, well-known methods, structures and techniques have not been shown in detail in order not to obscure an understanding of the specification.

Similarly, it should be understood that in the foregoing description of exemplary embodiments of the present application, various features of the present application are sometimes grouped together in a single embodiment, figure, or description thereof in order to streamline the present application and to facilitate an understanding of one or more of the various application aspects. However, this disclosed method should not be construed to reflect the following intent: that is, the claimed application claims more features than features which are explicitly recited in each claim. Rather, as the claims reflect, inventive aspects lie in less than all features of a single embodiment as previously disclosed. Thus, the claims following the detailed description are hereby expressly incorporated into this detailed embodiments, with each claim standing on its own as a separate embodiment of the present application.

Those skilled in the art will appreciate that the modules in the equipment in the embodiments may be adapted and arranged in one or more equipment different from the embodiments. The modules or units or assemblies of the embodiments may be combined into one module or unit or assembly, and further divided into a plurality of sub-modules or sub-units or sub-assemblies. All of the features disclosed in the specification (including any accompanying claims, abstract and drawings), and all of the processes or elements of any method or equipment so disclosed, may be combined in any combination, except combinations where at least some of such features and/or processes or elements are mutually exclusive. Each feature disclosed in the specification (including any accompanying claims, abstract and drawings), may be replaced by alternative features serving the same, equivalent or similar purpose, unless expressly stated otherwise.

Moreover, those skilled in the art will appreciate that while some embodiments described herein include some features included in other embodiments rather than others, combinations of features of different embodiments are meant to be within the scope of the present application and to form different embodiments. For example, in the claims, any of the claimed protection embodiments may be used in any combination.

The various component embodiments of the present application may be implemented in hardware, in software modules running on one or more processors, or in a combination thereof. Those skilled in the art will appreciate that a microprocessor or digital signal processor (DSP) may be used in practice to implement some or all of the functions of some or all of the components in an image processing scheme in accordance with embodiments of the present application. The present application may also be implemented as equipment or a device program (for example, a computer program and a computer program product) for performing some or all of the methods described herein. Such a program implementing the present application may be stored on a computer readable medium, or may take the form of one or more signals. Such signals may be downloaded from an Internet website, or provided on a carrier signal, or provided in any other form.

It should be noted that the above-mentioned embodiments illustrate rather than limit the present application, and that those skilled in the art will be able to design alternative embodiments without departing from the scope of the appended claims. In the claims, any reference signs placed between parentheses shall not be construed as limiting the claim. The word ‘comprising’ does not exclude the presence of elements or steps not listed in a claim. The word ‘a’ or ‘an’ preceding an element does not exclude the presence of a plurality of such elements. The present application can be implemented by means of hardware including several distinct elements, and by means of a suitably programmed computer. In the unit claims enumerating several devices, several of these devices may be embodied by the same item of hardware. The use of the words first, second, third and the like does not indicate any order. These words may be interpreted as names.

1. A method for processing image, comprising:
determining whether a first convolutional layer pre-called currently comprises a first slice selection module during a process of carrying out a convolutional processing on an image by means of a convolutional neural network, wherein the convolutional neural network comprises a plurality of convolutional layers, and each of the convolutional layers comprises a plurality of feature maps;
inputting output data of a previous convolutional layer into the first slice selection module and the first convolutional layer respectively, in response to that the first convolutional layer comprises the first slice selection module;
generating a feature map weight vector by the first slice selection module based on the output data of the previous convolutional layer, wherein each point in the feature map weight vector corresponds to one of the feature maps in the first convolutional layer and a weight value;
determining a number N of target features based on a preset acceleration ratio;
adjusting weight values of other points except a first N points in the feature map weight vector to 0, and inputting adjusted feature map weight vector into the first convolutional layer, wherein a feature map corresponding to the first N points is the target feature map; and
obtaining output data based on that the first convolutional layer convolves the output data of the previous convolutional layer based on the target feature map.

2. (canceled)

3. The method according to claim 1, wherein said obtaining output data comprises:
determining the target feature map based on the adjusted feature map weight vector by the first convolutional layer; and
obtaining the output data by convolving the output data of the previous convolutional layer based on the target feature map.

4. The method according to claim 1, further comprising:
inputting the output data of the previous convolutional layer into the first convolutional layer respectively in response to that the first convolutional layer does not comprise the first slice selection module; and
obtaining the output data based on that the first convolutional layer convolves the output data of the previous convolutional layer based on all feature maps.

5. A device for processing image, comprising:
a determining module configured to determine whether a first convolutional layer pre-called currently comprises a first slice selection module during a process of carrying out convolutional processing on an image by means of a convolutional neural network, wherein the convolutional neural network comprises a plurality of convolutional layers, and each of the convolutional layers comprises a plurality of feature maps;
a first inputting module configured to respectively input output data of a previous convolutional layer into the first slice selection module and the first convolutional layer in response to that the first convolutional layer comprises the first slice selection module;
a first calling module configured to generate a feature map weight vector by the first slice selection module based on the output data of the previous convolutional layer, wherein each point in the feature map weight vector corresponds to one of the feature maps in the first convolutional layer and a weight value; determine a number N of target features based on a preset acceleration ratio; adjust weight values of other points except a first N points in the feature map weight vector to 0, and input adjusted feature map weight vector into the first convolutional layer, wherein a feature map corresponding to the first N points is the target feature map; and
a second calling module configured to obtain output data based on that the first convolutional layer convolves the output data of the previous convolutional layer based on the target feature map.

6. (canceled)

7. The device according to claim 5, wherein the first convolutional layer is configured to:
determine the target feature map based on the adjusted feature map weight vector; and
obtain the output data by convolving the output data of the previous convolutional layer based on the target feature map.

8. The device according to claim 5, further comprising a second inputting module configured to input the output data of the previous convolutional layer into the first convolutional layer respectively in response to that the first convolutional layer does not comprise the first slice selection module; and
a third calling module configured to obtain the output data based on that the first convolutional layer convolves the output data of the previous convolutional layer based on all contained feature maps.

9. (canceled)

10. (canceled)

11. (canceled)

12. A terminal, comprising: a memory, a processor and an image processing program stored in the memory and executable on the processor, wherein the method as claimed in claim 1 is implemented when the image processing program is executed by the processor.

13. A computer readable storage medium, wherein an image processing program is stored in the computer readable storage medium, the method according to claim 1 is implemented when the image processing program is executed by the processor.

14. (canceled)

15. A terminal, comprising: a memory, a processor and an image processing program stored in the memory and executable on the processor, wherein the image processing method as claimed in claim 3 is implemented when the image processing program is executed by the processor.

16. A terminal, comprising: a memory, a processor and an image processing program stored in the memory and executable on the processor, wherein the image processing method as claimed in claim 4 is implemented when the image processing program is executed by the processor.

17. A computer readable storage medium, wherein an image processing program is stored in the computer readable storage medium, the image processing method according to claim 3 is implemented when the image processing program is executed by the processor.

18. A computer readable storage medium, wherein an image processing program is stored in the computer readable storage medium, the image processing method according to claim 4 is implemented when the image processing program is executed by the processor.
